(19) United States
(12) Patent Application Publication
(10) Pub. No.: US 2026/0131863 A1
(43) Pub. Date: May 14, 2026

(54) ACTIVE REAR DIFFUSER

(71) Applicants: Hyundai Motor Company, Seoul (KR); Kia Corporation, Seoul (KR); Kyung Chang Industrial Co.,Ltd., Daegu (KR)

(72) Inventors: Dong Ha Kim, Hwaseong-Si (KR); Hak Lim Kim, Hwaseong-Si (KR); Hong Heui Lee, Hwaseong-Si (KR); Jin Young Yoon, Hwaseong-Si (KR); Kyu Jung Kim, Daegu (KR); Jin Bo Kim, Daegu (KR); Hyeong Seok Joo, Daegu (KR); Hueon Uk Kim, Daegu (KR)

(21) Appl. No.: 19/255,562

(22) Filed: Jun. 30, 2025

(30) Foreign Application Priority Data
Nov. 14, 2024 (KR) 10-2024-0161988

(51) Int. Cl. B62D 35/00

(52) U.S. Cl. CPC B62D 35/007

(57) ABSTRACT

Proposed is a diffuser, such as an active rear diffuser. The diffuser may include a diffuser body; an actuator configured to supply a mechanical force; a gear assembly coupled to the actuator; and a deployment linkage. The gear assembly may be configured to, based on the mechanical force of the actuator, perform a tilting operation by tilting, with respect to the vehicle, the diffuser body. The deployment linkage may be configured to, based on the mechanical force of the actuator and after completion of the tilting operation, deploy the diffuser body.

### CROSS-REFERENCE TO RELATED APPLICATION

The present application claims priority to Korean Patent Application No. 10-2024-0161988, filed Nov. 14, 2024, the entire contents of which are incorporated herein by reference for all purposes.

### TECHNICAL FIELD

The present disclosure relates to an active rear diffuser of a vehicle.

### BACKGROUND

An object moving through air is subject to an aerodynamic force due to a relative motion between the air and the object. The aerodynamic force may include lift force that is exerted perpendicular to a direction of the relative motion of the object and drag force that is exerted parallel to the direction of the relative motion.

A vehicle in a driving state is also subject to aerodynamic force due to a relative motion between the vehicle and the air. The reduction of the aerodynamic force applied to the vehicle may increase the driving stability of the vehicle and may also increase the energy efficiency and the fuel efficiency of the vehicle. Thus, the reduction of the aerodynamic forces applied to the vehicle is an important part of vehicle design and development.

### SUMMARY

Accordingly, the present disclosure has been made keeping in mind the above problems occurring in the related art, and an objective of the present disclosure is to provide an active rear diffuser and a vehicle including the active rear diffuser capable of increasing the aerodynamic force performance.

Another objective of the present disclosure is to provide an active rear diffuser and a vehicle including the active rear diffuser capable of being tilted and extended by a single actuator.

Still another objective of the present disclosure is to provide an active rear diffuser and a vehicle including the active rear diffuser having an advantage in terms of packaging.

Yet another objective of the present disclosure is to provide an active rear diffuser and a vehicle including the active rear diffuser capable of minimizing failure caused by a complex driving component.

Yet another objective of the present disclosure is to provide an active rear diffuser and a vehicle including the active rear diffuser capable of reducing the cost.

The objectives that can be obtained from the present disclosure are not limited to the above-mentioned objectives, and other objectives not mentioned herein will be clearly understood by one having ordinary skill in the art from the following description.

In order to achieve the objectives of the present disclosure as described above and to perform the characteristic functions of the present disclosure as described later, the features of the present disclosure are as follows.

According to an embodiment of the present disclosure, a diffuser of a vehicle may comprise a diffuser body, an actuator, a tilting mechanism configured to tilt the diffuser body by driving the actuator and a deployment mechanism configured to deploy the diffuser body through the driving of the actuator and by a completion of a tilting operation of the tilting mechanism.

According to an embodiment of the present disclosure, a diffuser of a vehicle may comprise a bracket, a cover configured to tilt with respect to the bracket, and a diffuser body configured to be deployed with respect to the cover. The diffuser body may be configured to be deployed after the cover is completely tilted.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a side view schematically illustrating a vehicle;

FIG. 2A is a view illustrating a retracted position of an example active rear diffuser in a rear lower region of a vehicle;

FIG. 2B is a view illustrating a tilted position of an example active rear diffuser in a rear lower region of a vehicle;

FIG. 2C is a view illustrating a deployed position of an example active rear diffuser in a rear lower region of a vehicle;

FIG. 3 is a perspective view illustrating an example active rear diffuser;

FIG. 4 is an exploded perspective view illustrating an example active rear diffuser;

FIG. 5 is a view illustrating the retracted position of an example active rear diffuser;

FIG. 6 is a view illustrating the tilted position of an example active rear diffuser;

FIG. 7 is a view illustrating the deployed position of an example active rear diffuser;

FIG. 8 is a view illustrating a power transmission mechanism of an example active rear diffuser;

FIG. 9 is an exploded perspective view of an operation mechanism of an example active rear diffuser;

FIG. 10 is an assembled perspective view of the operation mechanism of an example active rear diffuser;

FIG. 11A is a side view illustrating the operation mechanism in the retracted position of an example active rear diffuser;

FIG. 11B is a side view illustrating the operation mechanism in the tilted position of an example active rear diffuser;

FIG. 12 is a view illustrating a brake of an example active rear diffuser;

FIG. 13 is an upper side view illustrating the operation mechanism of an example active rear diffuser;

FIG. 14 and FIG. 15 are views illustrating an operation of the brake of an example active rear diffuser;

FIGS. 16A and 16B show an operation of a deployment mechanism of an example active rear diffuser;

FIG. 17 is a view illustrating a state before a link structure of the deployment mechanism;

FIG. 18 is a view illustrating a state after the link structure of the deployment mechanism; and

FIG. 19 shows an example computing system.

### DETAILED DESCRIPTION

Specific structures and functions described in connection with one or more embodiments of the present disclosure are presented as examples and embodiments according to the spirit of the present disclosure can be achieved in various ways. Furthermore, the present disclosure should not be construed as being limited to the following example embodiments and should be construed as including all changes, equivalents, and replacements included in the spirit and scope of the present disclosure.

Furthermore, in the present disclosure, terms including “first” and/or “second” may be used to describe various components, but the components are not limited to the terms. The terms are used to distinguish one component from another component, and for instance, a first component may be referred to as a second component, and similarly, a second component may be referred to as a first component without departing from the scope according to the spirit of the present disclosure.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

It should be understood that when one component is referred to as being “connected to” or “coupled to” another component, it may be connected directly to or coupled directly to another component or be connected to or coupled to another component, having the other component intervening therebetween. On the other hand, it is to be understood that when one component is referred to as being “connected directly to” or “in contact directly with” another component, it may be connected to or coupled to another component without the other component intervening therebetween. Expressions for describing relationships between components, that is, “between,” “directly between,” “adjacent to,” and “directly adjacent to” should be construed in the same way.

Like components will be denoted with like reference numerals throughout the specification. In addition, terms used in the specification are used to describe example embodiments of the present disclosure and are not intended to limit the scope of the present disclosure. In the specification, the terms of a singular form may include plural forms unless otherwise specified. It will be further understood that the terms “comprise,” “include,” “have,” and so on when used in this specification, specify the presence of stated components, steps, operations, and/or elements, but do not preclude the presence or addition of one or more other components, steps, operations, and/or elements thereof.

An active aerodynamic component that is deployed based on the driving speed of the vehicle may be mounted on the vehicle to improve the stability and the energy efficiency of the vehicle. The active aerodynamic component may also enhance the aesthetics of the vehicle, for example, by being integrated into the vehicle body when not in active use.

Hereinafter, the present disclosure will be described in detail with reference to the accompanying drawings.

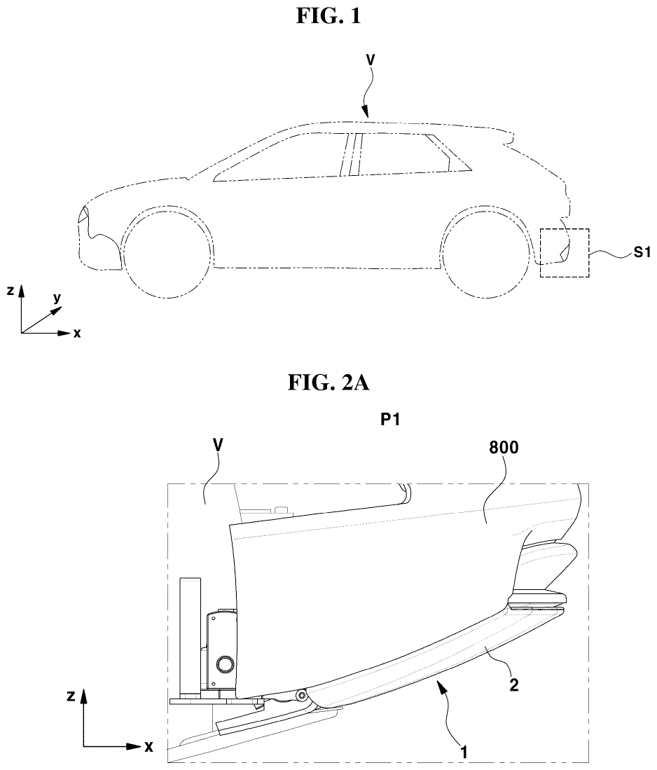

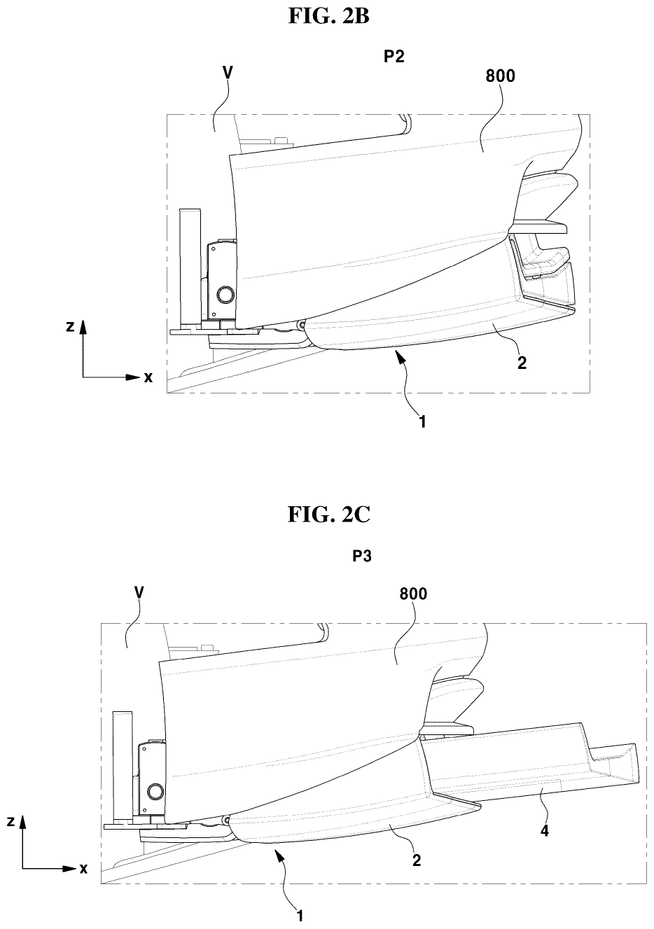

As illustrated in FIGS. 1, 2A, 2B, and 2C, a vehicle V may include an active rear diffuser 1. The active rear diffuser 1 may be mounted on a rear lower region S1 of the vehicle V. Specifically, the active rear diffuser 1 may be mounted on a rear bumper 800 of the vehicle V. Although the active diffuser is referred to as and described as an active “rear” diffuser throughout this disclosure, one of skill in the art would understand that the active diffuser according to the present disclosure may be installed at any location of the vehicle other than the rear portion of the vehicle. For example, the active diffuser may be installed on a front of the vehicle (e.g., on a front bumper), on a roof of the vehicle, on a top rear portion (e.g., on a trunk, on a rear hatch, etc.) of the vehicle (e.g., a whale tail), on a cab of the vehicle, on a truck bed of the vehicle, etc. The active diffuser may also be referred to as a diffuser.

The active rear diffuser 1 may control the flow of air from or around a rear lower portion of the vehicle V. For example, the active rear diffuser 1 may control a high-speed air flow moving under the vehicle V with respect to a low-speed (e.g., lower speed than the air flow under the vehicle V) air flow of the surrounding atmosphere, thereby being capable of reducing aerodynamic drag, generating a downforce, and/or increasing overall handling performance. Particularly, the active rear diffuser 1 may increase the stability of the vehicle V while the vehicle V is driving at a high speed.

The active rear diffuser 1 may be configured to be deployed or retracted. For example, the active rear diffuser 1 may be deployed or retracted based on the speed of the vehicle V. The position of the active rear diffuser 1 may be controlled such that the active rear diffuser 1 is deployed or retracted based on the speed and the power supply of the vehicle V. When the active rear diffuser 1 is deployed, the active rear diffuser 1 may be tilted.

As illustrated in FIGS. 2A, 2B, and 2C, the active rear diffuser 1 may include a retracted position P1, a tilted position P2, and a deployed position P3. As illustrated in FIG. 2A, in the retracted position P1, the active rear diffuser 1 may be stored (e.g., stowed) in the vehicle V. As illustrated in FIG. 2B, in the tilted position P2, the active rear diffuser 1 may be tilted at a predetermined angle with respect to the retracted position P1. As illustrated in FIG. 2C, the active rear diffuser 1 may extend from the tilted position P2 to (e.g., toward) the outside of the vehicle V by a predetermined length.

The active rear diffuser 1 may include a cover 2 that is tiltable and a diffuser body 4 that is slidable. In the tilted position P2, the cover 2 that is tiltable may be capable of being tilted (e.g., tilted downward) with respect to the rear bumper 800. When the active rear diffuser 1 is transitioned from the tilted position P2 to the deployed position P3, the diffuser body 4 may protrude from the cover 2, which is tiltable, to (e.g., toward) the outside of the vehicle V.

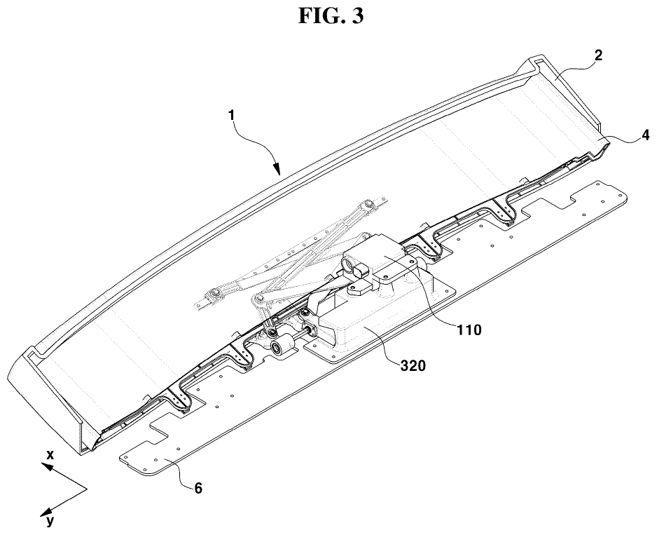

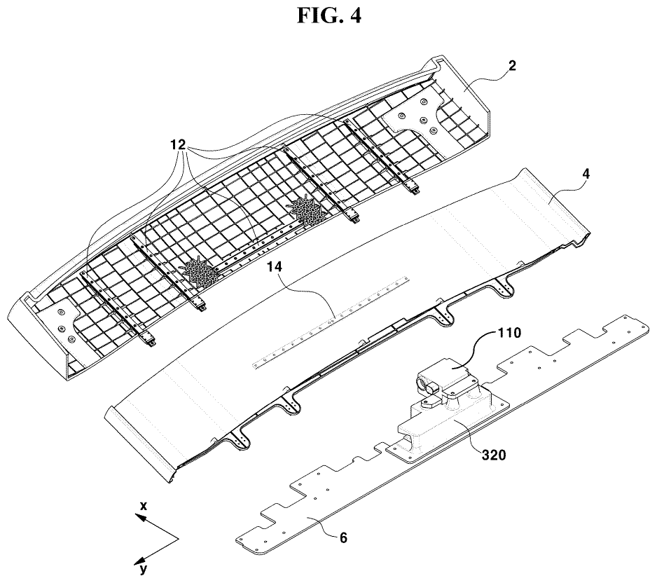

FIG. 3 is a perspective view illustrating an example active rear diffuser. FIG. 4 is an exploded perspective view illustrating an example active rear diffuser. As illustrated in FIG. 3 and FIG. 4, the cover 2 and the diffuser body 4 may be connected to the vehicle V through a fixing bracket 6 (also referred to as a bracket 6). The fixing bracket 6 may be fixed (e.g., affixed) to a body of the vehicle V. In other words, the fixing bracket 6 may fix (e.g., affix, mount, etc.) the active rear diffuser 1 to the vehicle V. A stopper body (also referred to as a stopper) 320 may be mounted on the fixing bracket 6. The cover 2 may be mounted such that the cover 2 is capable of being rotated with respect to the fixing bracket 6. A track 14 may be provided on the diffuser body 4. The diffuser body 4 may be connected to the fixing bracket 6 such that the diffuser body 4 is capable of being slid in or out with respect to the cover 2. The cover 2 may include a plurality of guide rails 12. The plurality of guide rails 12 may be configured to guide a sliding movement of the diffuser body 4 with respect to the cover 2. The diffuser body 4 may include one or more guide portions guided by the plurality of guide rail 12. The guide portion(s) of the diffuser body 4 may be, for example, a groove, a matching rail, etc. Each of the guide portion(s) of the diffuser body 4 may be configured to fit a different one the plurality of guide rails 12 such that the sliding movement of the diffuser body 4 may conform to the position and/or the orientation of the plurality of guide rails 12.

The active rear diffuser 1 may be operated by a drive. The drive may be, for example, a motor, an actuator, a servo, etc. The drive may be electrically powered to control the movement of the active rear diffuser 1. Tilting, deploying, and retracting of the active rear diffuser 1 may be performed by, for example, an actuator 110. Having a single actuator 110 may minimize the occurrence of failure by simplifying the control of the active rear diffuser 1 and may provide advantages of excellent space utilization and cost reduction. Alternatively, the drive for the active rear diffuser 1 may include two or more actuators. In an example, the actuator 110 may be a motor. The actuator 110 may provide a mechanical force (e.g., a rotational force, a torque, etc.) to one or more other components as described herein.

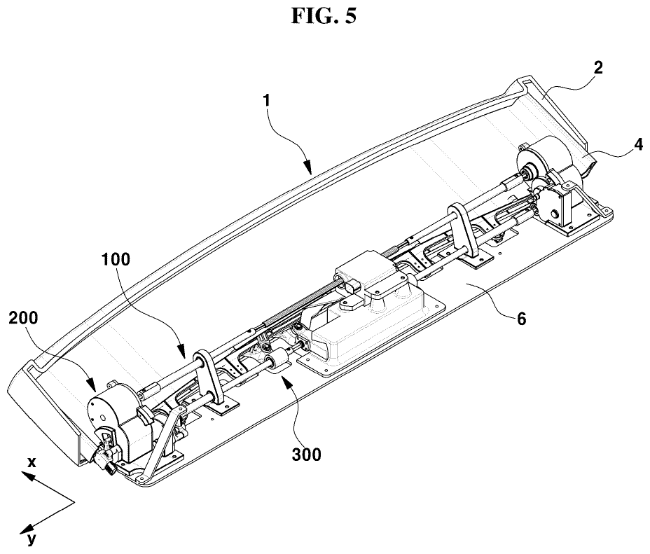

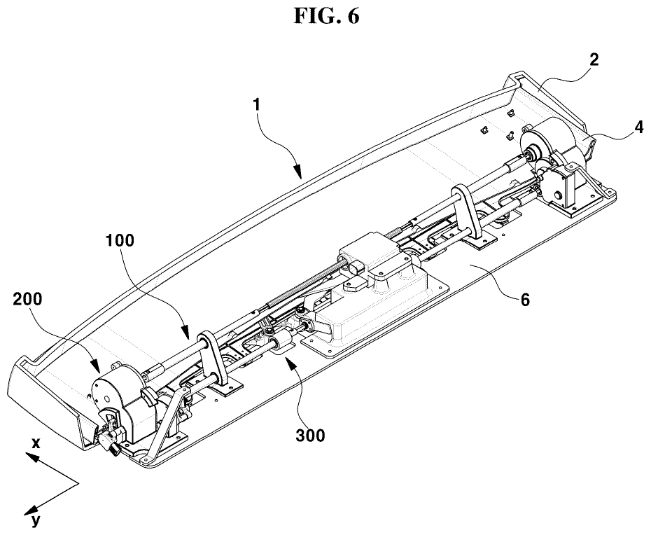

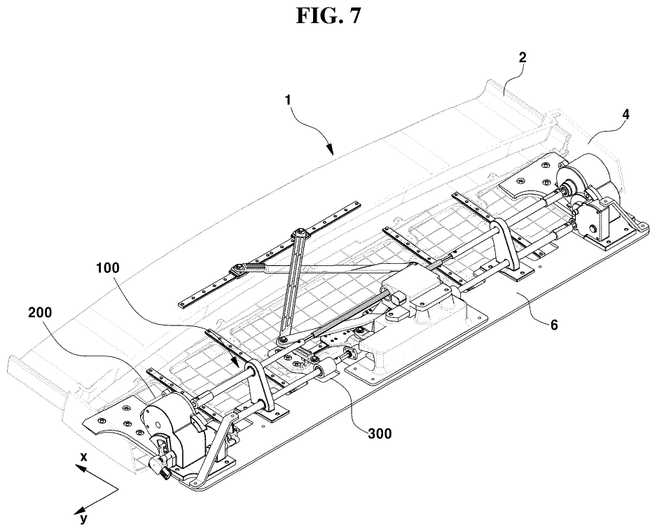

FIG. 5 is a view illustrating the retracted position of an example active rear diffuser. FIG. 6 is a view illustrating the tilted position of an example active rear diffuser. FIG. 7 is a view illustrating the deployed position of an example active rear diffuser. As illustrated in FIGS. 5, 6, and 7, the active rear diffuser 1 may include an operation mechanism for operating the active rear diffuser 1. Specifically, the active rear diffuser 1 may include a power transmission mechanism 100, a tilting mechanism 200, and a deployment mechanism 300. The power transmission mechanism 100 may be configured such that power (e.g., a mechanical force, a rotational force, a torque, etc.) is transmitted from the single actuator 110 to the tilting mechanism 200 and the deployment mechanism 300. The power transmission mechanism 100 may include, for example, one or more of an axle, a shaft, a rotator, a belt, a chain, a gear, etc. The tilting mechanism 200 may be configured to receive the power from the power transmission mechanism 100 and may be configured to perform a tilting operation of the cover 2 as illustrated in FIG. 6. The deployment mechanism 300 (e.g., a deployment linkage, a deployment linkage assembly, etc.) may be configured to receive power from the power transmission mechanism 100 and may be configured to perform a deployment operation of the diffuser body 4 as illustrated in FIG. 7 by the tilting operation of the tilting mechanism 200 or by the completion of the tilting operation (e.g., during the tilting operation or after the tilting operation is complete).

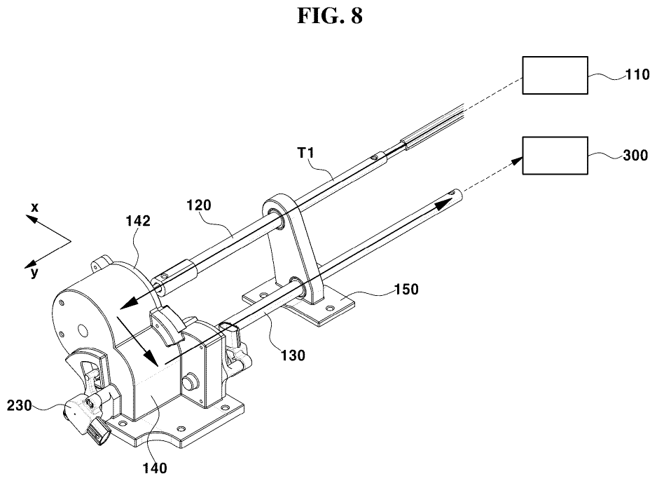

FIG. 8 is a view illustrating a power transmission mechanism of an example active rear diffuser. The power transmission mechanism 100 (e.g., a power transmission, a transmission, a power transmission actuator assembly, etc.) may include the actuator 110, a main shaft 120, and a transmission shaft 130. The main shaft 120 may be connected to the actuator 110. Particularly, the main shaft 120 may be directly connected to the actuator 110 and may be rotated by driving of the actuator 110.

The tilting mechanism 200 (e.g., a tilting gear assembly, a gear assembly, etc.) may include a housing 140, a housing cover 142, and one or more gears (e.g., a gear assembly, a gearbox, a transmission, etc.). The main shaft 120 may be connected to the housing 140. Gears capable of changing an output path connected to an input of the main shaft 120 may be disposed in the housing 140. In an example, the housing 140 may further include the housing cover 142 that is capable of being coupled to the housing 140. Specifically, the input (e.g., rotating power input) of the main shaft 120 may be output (e.g., transferred) to the tilting mechanism 200 so that the tilting operation can be enabled. The input (e.g., rotating power input) of the main shaft 120 may be output (e.g., transferred) to the deployment mechanism 300 so that the deployment operation can be enabled. A detailed structure thereof will be described later. Therefore, the power of the actuator 110 may be transmitted to the transmission shaft 130 through the housing 140 (e.g., through one or more gears disposed in the housing 140). In other words, as indicated by an arrow of a power transmission path T1, a driving force of the actuator 110 may be transmitted through the main shaft 120, the housing 140 (e.g., one or more gears in the housing 140), and the transmission shaft 130. The driving force of the actuator 110 may enable the tilting operation and the deployment operation of the active rear diffuser 1. The main shaft 120 and the transmission shaft 130 may receive an additional support force by a support bracket 150.

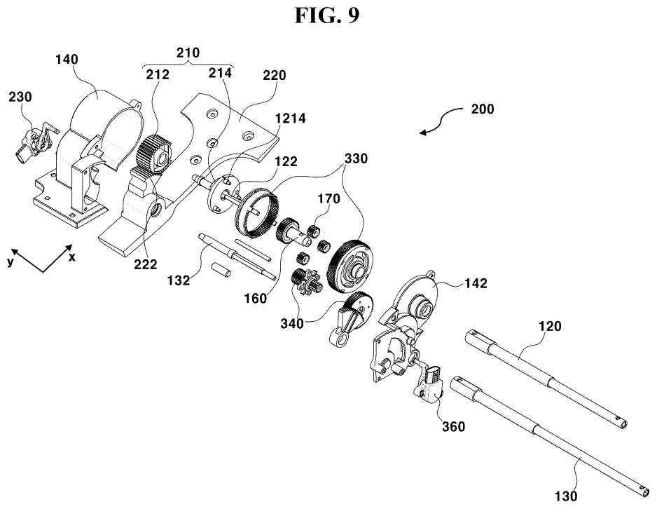

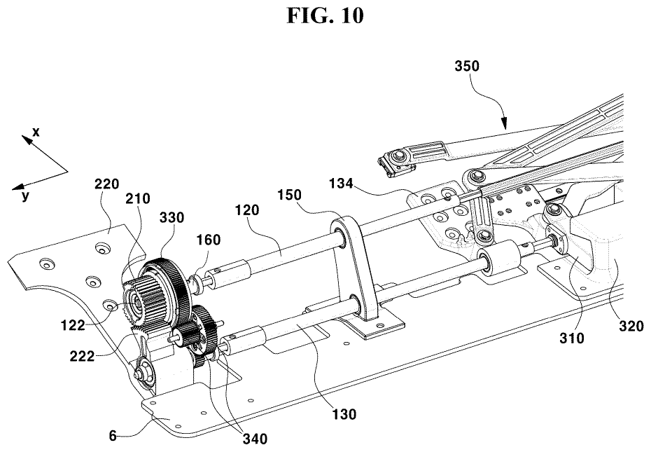

FIG. 9 is an exploded perspective view of an operation mechanism of an example active rear diffuser. FIG. 10 is an assembled perspective view of the operation mechanism of an example active rear diffuser. Referring to FIG. 9 and FIG. 10, the tilting mechanism 200 for the tilting operation may be accommodated in the housing 140. In particular, FIG. 9 is an exploded perspective view of an operation mechanism (e.g., the tilting mechanism 200) of an example active rear diffuser, and FIG. 10 is an assembled perspective view of the operation mechanism (e.g., the tilting mechanism 200) of an example active rear diffuser. The tilting mechanism 200 may include a carrier gear 210 and a tilting gear 220.

The main shaft 120 may be connected to a gear shaft 122 so that the gear shaft 122 is capable of being rotated together with the main shaft 120. In addition, a sun gear 160 and the carrier gear 210 are mounted in the gear shaft 122. The sun gear 160 may be configured such that the sun gear 160 always rotates together with the gear shaft 122. The carrier gear 210 may rotate together with the gear shaft 122. The carrier gear 210 may not rotate together with the gear shaft 122 if the carrier gear 210 is restrained by the tilting gear 220 that will be described later. The sun gear 160 and the carrier gear 210 may be disposed to be adjacent to each other. Furthermore, as will be described later, rotation of the carrier gear 210 or rotation of a ring gear (e.g., an internal gear) 330 may be selectively enabled by the sun gear 160 and a plurality of satellite gears (also referred to as planet gears or planetary gears) 170 disposed along an outer circumference of the sun gear 160.

The carrier gear 210 may be configured such that the carrier gear 210 is rotated as the rotation force of the main shaft 120, during the tilting operation, is transmitted to the carrier gear 210. The carrier gear 210 may be configured such that the carrier gear 210 is engaged with the tilting gear 220. The carrier gear 210 may include a tooth gear (also referred to as a spur gear) 212 having teeth formed on an outer circumferential surface of the tooth gear 212. The tilting gear 220 may include teeth 222. Therefore, when the carrier gear 210 is rotated, the tilting gear 220 may rotate together with the carrier gear 210. The tilting gear 220 may be disposed in the housing 140 such that the tilting gear 220 rotates with respect to the transmission shaft 130. In other words, the tilting gear 220 may have an axis of rotation that coincides with (e.g., coaxial with) the transmission shaft 130. The tilting gear 220 may have a rigid protrusion (e.g., a bracket) portion that is configured to couple (e.g., rigidly couple) to the cover 2 and/or the diffuser body 4 such that the diffuser body 4 can also rotate along the transmission shaft 130.

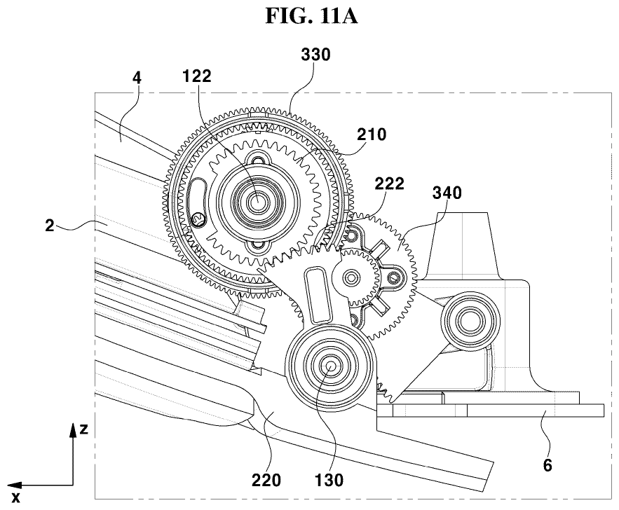

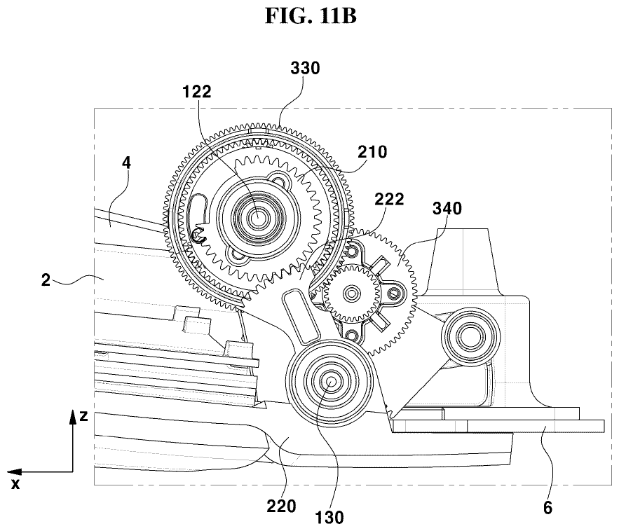

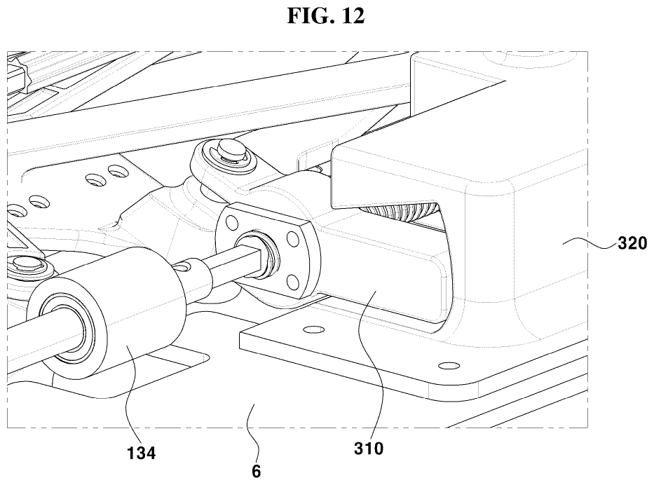

FIG. 11A is a side view illustrating the operation mechanism in the retracted position of the active rear diffuser. FIG. 11B is a side view illustrating the operation mechanism in the tilted position of the example active rear diffuser. The active rear diffuser 1 may be positioned in the retracted position P1. A distal end portion of the tilting gear 220 may be coupled to the cover 2, and a proximal end portion of the tilting gear 220 may be movably disposed below the fixing bracket 6. Therefore, when the tilting gear 220 is rotated by the rotation of the carrier gear 210, the cover 2 may be rotated simultaneously, as illustrated in FIG. 11B, so that the active rear diffuser 1 can be placed in the tilted position P2.

Since the rotation of the proximal end portion of the tilting gear 220 is limited (e.g., terminated) by the fixing bracket 6, the tilting operation may be completed when the tilting gear 220 reaches (e.g., comes in contact with) the fixing bracket 6. The maximum possible tilting angle may be adjusted by adjusting the position of the proximal end portion of the tilting gear 220. In an example, the maximum tilting angle may be set to 15 degrees. A tilting sensor 230 (as shown in FIG. 9) configured to measure the tilting amount of the cover 2 may be provided.

FIG. 12 is a view illustrating a brake of an example active rear diffuser. The deployment operation may be allowed by the tilting operation or by the completion of the tilting operation (e.g., the deployment operation may commence during the tilting operation, at completion of the tilting operation, or after completion of the tilting operation). As illustrated in FIG. 12, the deployment mechanism 300 may include a brake 310. The brake 310 may include a protrusion (e.g., a catch) that rotates about an axis and protrudes away from the axis. The brake 310 may be placed in a locked state in the retracted position P1 of the active rear diffuser 1. The brake 310 may be placed in an unlocked state after the tilting operation is completed. The brake 310 may be configured to limit (e.g., prevent) the operation of the deployment mechanism 300 during the tilting operation. The movement of the brake 310 may be limited by the stopper body 320 mounted on the fixing bracket 6.

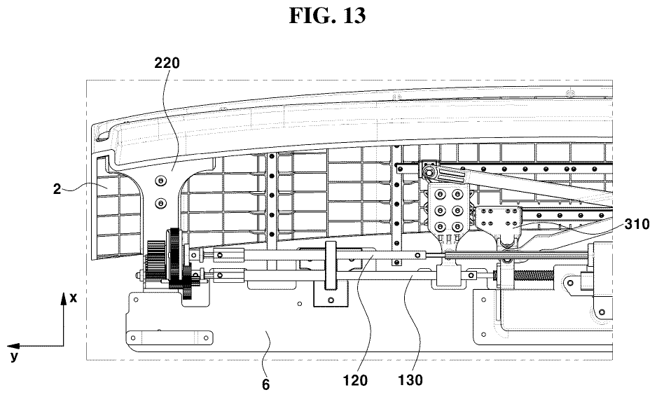

FIG. 13 is an upper side view illustrating the operation mechanism of an example active rear diffuser. The brake 310 may be mounted on the transmission shaft 130. Therefore, the brake 310 may be connected to the tilting gear 220 via the transmission shaft 130. When the tilting gear 220 is tilted, the brake 310 connected to the transmission shaft 130 may also be rotated. Accordingly, the brake 310 may be unlocked when or after the transmission shaft 130 rotates (e.g., for more than a threshold angle).

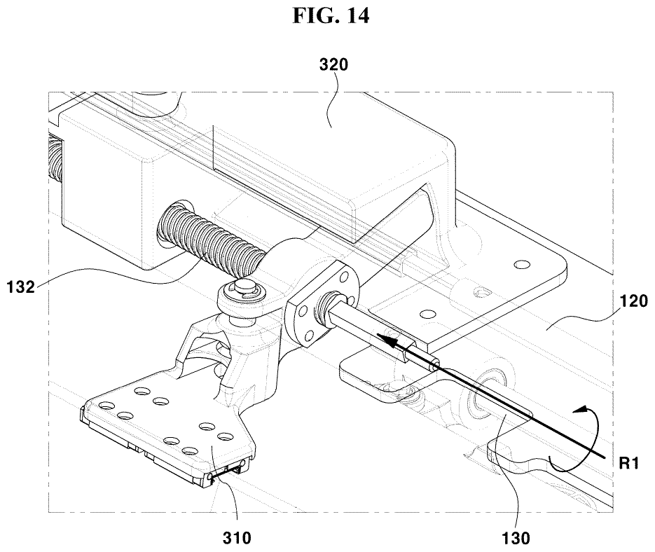

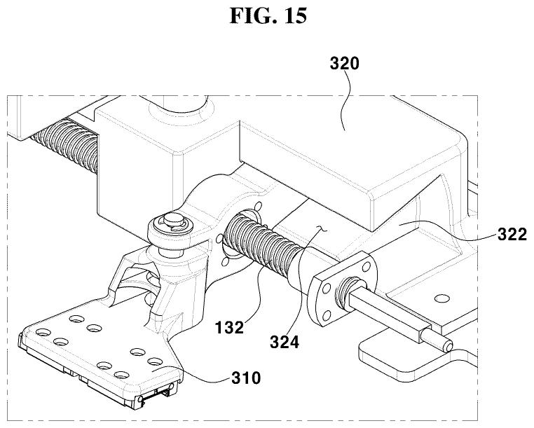

FIG. 14 and FIG. 15 are views illustrating an operation of the brake of an example active rear diffuser. In the retracted position P1 of the active rear diffuser 1, the brake 310 may be in a state in which the brake 310 cannot be moved because it is hindered (e.g., blocked, caught, etc.) by a stopping surface 322. As illustrated in FIG. 14, if the rotation of the tilting gear 220 is input (e.g., if the rotation force is transmitted) through the transmission shaft 130 in a rotational direction R1, the brake 310 may also rotate in the direction R1. When (e.g., while or after) the brake 310 rotates, the brake 310 may escape from the stopping surface 322, move toward a passage 324 (e.g., a cavity) formed in the stopper body 320, and move inside the passage 324. This may be realized by the deployment mechanism 300 (e.g., by the rotation of the ring gear 330).

As shown in FIG. 9 and FIG. 10, the deployment mechanism 300 may include the ring gear 330 and a transmission gear 340. The ring gear 330 may be disposed coaxially with the main shaft 120 and may be mounted on the gear shaft 122. The sun gear 160 may be disposed at a center portion of the ring gear 330, and the plurality of satellite gears 170 may be disposed between the sun gear 160 and the ring gear 330. Each of the satellite gears 170 may be mounted on the carrier gear 210 such that each satellite gear 170 is capable of being rotated. In an example, the carrier gear 210 may include a disc 214 that is formed integrally with the tooth gear 212 or coupled to the tooth gear 212. A mounting portion 1214 for mounting the satellite gear 170 may be provided on the disc 214 along a circumferential direction of the disc 214. The satellite gear 170 may be disposed on (e.g., rotatably affixed to) the mounting portion 1214.

The transmission gear 340 may be disposed between the ring gear 330 and the transmission shaft 130. In an example, the transmission gear 340 may be configured to be in external contact with the ring gear 330 and also to be in external contact with the transmission shaft 130. Therefore, the rotation of the ring gear 330 may be capable of being transmitted to the transmission shaft 130 through the transmission gear 340.

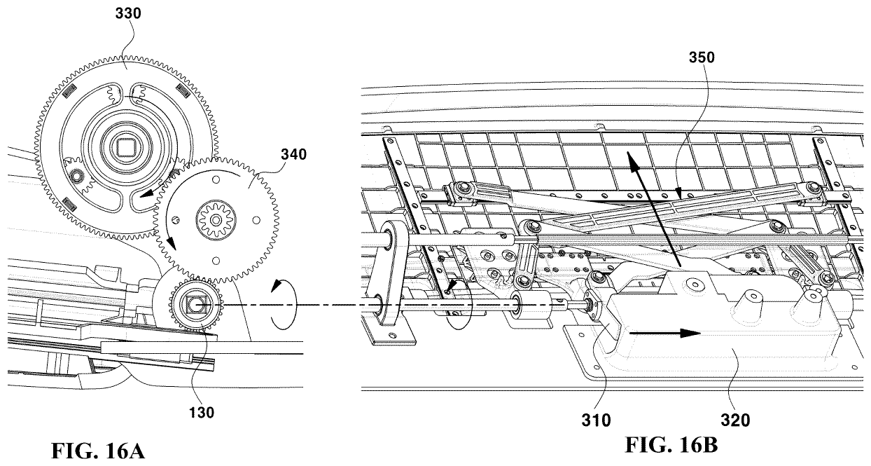

FIGS. 16a and 16b show an operation of a deployment mechanism of an example active rear diffuser. When (e.g., while) the tilting operation is performed, the transmission shaft 130 may not be capable of being rotated due to the brake 310, so the ring gear 330 may be fixed (e.g., terminated in movement). Therefore, the rotation of the sun gear 160 may be transmitted to the carrier gear 210, thereby rotating the carrier gear 210. The satellite gear 170 that is in internal contact with the ring gear 330 may be configured to rotate along an inner circumference of the ring gear 330 that is fixed.

When the tilting operation is complete, the carrier gear 210 may not rotate (e.g., not rotatable) due to fixing of the tilting gear 220 by the fixing bracket 6. Instead, since the brake 310 is unlocked after the tilting operation is completed, the ring gear 330 may be capable of being rotated as illustrated in FIG. 16A. That is, the rotation of the sun gear 160 may be capable of being transmitted to the ring gear 330 through the satellite gear 170. When (e.g., while) the ring gear 330 rotates, the transmission gear 340 may also rotate, and a rotational force of the transmission gear 340 may be transmitted to the transmission shaft 130.

As illustrated in FIG. 16B, when the transmission shaft 130 rotates, the brake 310, which may be simultaneously rotated and escaped from the stopping surface 322, may move within the passage 324. A threaded rod 132 may be coaxially connected to the transmission shaft 130. The brake 310 may be capable of being moved within the passage 324 along the threaded rod 132. The movement of the brake 310 may enable the deployment operation of the diffuser body 4 through a link structure 350.

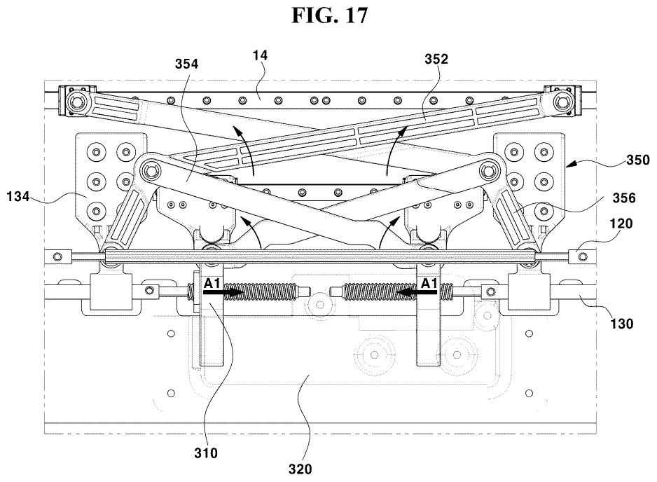

FIG. 17 is a view illustrating a state before a link structure of the deployment mechanism. The deployment mechanism 300 may include the link structure (also referred to a linkage, a mechanical linkage, links, or link arms) 350. The link structure 350 may be operatively connected to the diffuser body 4 to allow the diffuser body 4 to be slid in and out of the vehicle V. The link structure 350 may, for example, be a scissor linkage such that the link structure 350 may extend or contract (e.g., in length) based on the position of the brake 310 (or the distance between a pair of brakes 310). The link structure 350 may extend as the brake 310 moves centerward (e.g., toward a center of the stopper body 320 or away from the tilting mechanism 200), as indicated by the arrows A1. The link structure 350 may contract as the brake 310 moves outward (e.g., away from a center of the stopper body 320 or toward the tilting mechanism 200), which is a direction opposite of the arrows A1. The link structure 350 may include a main link 352, a connection link (also referred to as a connecting link) 354, and an auxiliary link 356.

A distal end portion of the main link 352 may be connected to the diffuser body 4, and a proximal end portion of the main link 352 may be coupled to the transmission shaft 130 such that the main link 352 is capable of being rotated (e.g., around an axis of rotation coinciding with the transmission shaft 130). The proximal end portion of the main link 352 may be mounted on a bracket 134 that is mounted on (e.g., affixed to) the transmission shaft 130 and coupled to the cover 2.

A proximal end portion of the connection link 354 may be coupled to the brake 310 such that the proximal end portion of the connection link 354 is capable of being rotated. A distal end portion of the connection link 354 may be rotatably coupled to the main link 352. The distal end portion of the connection link 354 may be coupled to a predetermined point (e.g., a point of inflection of the main link 352, where the main link 352 is bent at an angle) between the distal end portion of the main link 352 and the proximal end portion of the main link 352.

The link structure 350 may further include the auxiliary link 356. If the auxiliary link 356 is included in the link structure 350, a proximal end portion of the auxiliary link 356 may be rotatably coupled to the transmission shaft 130. The proximal end portion of the main link 352 and the distal end portion of the connection link 354 may be connected to a distal end portion of the auxiliary link 356.

As shown in FIG. 17 and other figures, the various structures as described herein in reference to FIGS. 8-10, 11A, 11B, 12-15, 16A, and 16B, such as the power transmission mechanism 100, the tilting mechanism 200, and the deployment mechanism 300, may be provided in pairs. One set of the pair of components provided in each side of, for example, the actuator 110 in a substantially symmetrical configuration. For example, as shown in FIGS. 5-6, a pair of identical or mirror-image power transmission mechanisms 100 may be provided, each on either side of the actuator 110. A pair of identical or mirror-image tilting mechanisms 200 may be provided, each on each side of the actuator 110. A pair of identical or mirror-image deployment mechanisms 300 may be provided, each on either side of the actuator 110. The actuator 110 may be coupled to both sets of components, and control and operate both. The actuator 110 may, for example, control and operate both sets of components simultaneously such that the active rear diffuser may be operated by both sets of components in sync.

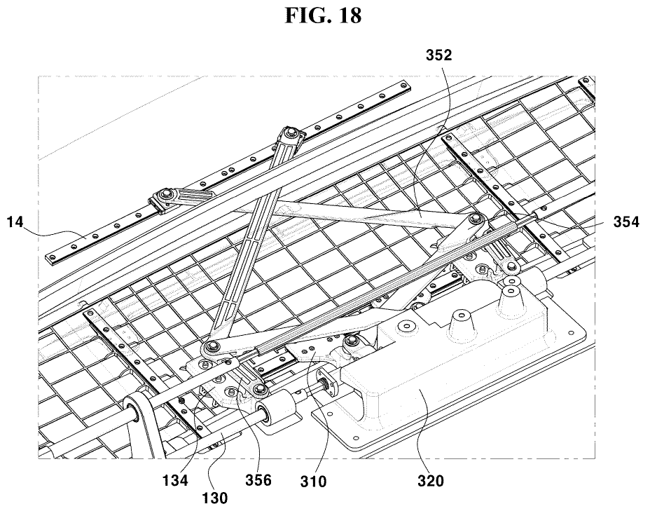

Furthermore, referring to FIG. 18, when the brake 310 is unlocked after the tilting operation (e.g., after completion of the tilting operation), the brake 310 may become capable of moving along the passage 324. That is, the brake 310 may be capable of moving toward the center portion (in the A1 direction or away from the tilting mechanism 200) of the stopper body 320. Due to the movement of the brake 310 toward the center portion of the stopper body 320, the distal end portion of the connection link 354 may extend while being rotated, and the main link 352 connected to the connection link 354 may also extend while being rotated. The distal end portion of the main link 352 may be guided to move in a direction along the y-axis, as shown in FIG. 18, along the track 14 provided on the diffuser body 4. The movement of the link structure 350 may cause the active rear diffuser 1 to be disposed in (e.g., move to, transform to, etc.) the deployed position P3. As such, since the link structure 350 according to the present disclosure adopts arms (e.g., links, link arms, etc.) having an X shape (e.g., a scissor linkage), a smaller storage space may be achieved relative to the deployment amount (e.g., a length of deployment).

The active rear diffuser 1 may include a deployment sensor 360 (as shown in FIG. 9) capable of measuring the deployment amount (e.g., a position) of the diffuser body 4. The tilting operation or the deployment operation of the active rear diffuser 1 may be controlled based on a sensing value of the tilting sensor 230 or the deployment sensor 360 mentioned above.

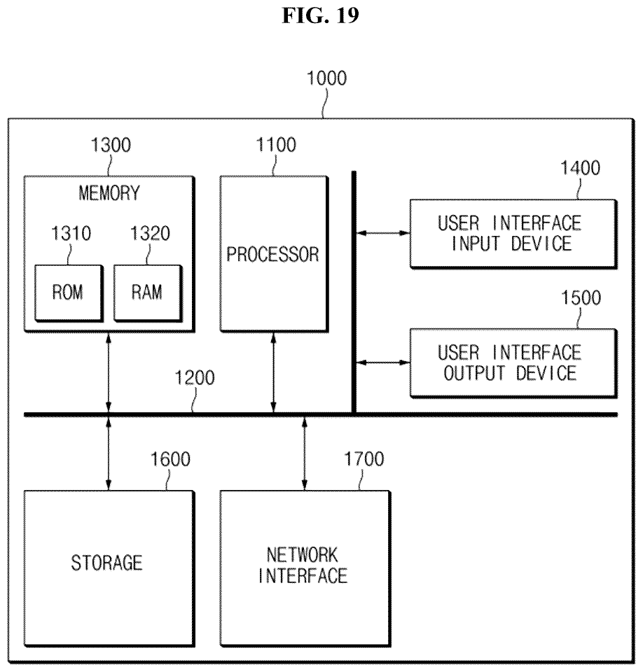

FIG. 19 shows an example computing system (e.g., a computing device of a vehicle or any other apparatus). One or more controllers, processors, etc. described herein may be implemented by a computing system 1000 or may be implemented in the computing system 1000. In some implementations, one or more components of the computing system 1000 may be omitted and/or one or more additional components may be added. For example, the operation of the active rear diffuser 1 may be controlled by the computing system 1000. For example, the computing 1000 may control the operation (e.g., ON/OFF status, a rotational speed, a direction of rotation, etc.) of the actuator 110. The computing system 1000 may communicate with the tilting sensor 230 and the deployment sensor 360, for example, to receive information (e.g., a current position, a tilt angle, deployment status, etc.) regarding the cover 2 and/or the diffuser body 4. The computing system 1000 may, for example, control the active rear diffuser 1 to be deployed (e.g., transform in to a deployment position) in response to receiving an indication (e.g., a signal from a sensor such as a speedometer) that the speed of the vehicle has reached (e.g., is greater than) a first threshold speed. Conversely, the computing system 1000 may, for example, control the active rear diffuser 1 to be retracted (e.g., transform into a retraction position) in response to receiving an indication (e.g., a signal from a sensor such as a speedometer) that the speed of the vehicle has reached (e.g., is less than) a second threshold speed. The first threshold speed may be different from the second threshold speed. For example, the first threshold speed may be greater than the second threshold speed. Alternatively, the first threshold speed may be less than the second threshold speed.

A computing system 1000 may include at least one processor 1100, memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read-only memory (ROM) and a random access memory (RAM).

Communication interface(s) (also referred to as communication device(s), communicator(s), communication module(s), communication unit(s), etc.), such as the network interface 1700, may allow software and/or data to be transferred between a device and one or more external devices, and/or between one or more components of a device. Communication interface(s) may include a receiver, a transmitter, a transceiver, a modem, a network interface and/or adapter (such as an Ethernet adapter), a radio transceiver, an antenna, a communication port, a Personal Computer Memory Card International Association (PCMCIA) slot and card, or the like. Software and data transferred via communication interface(s) may be in the form of signals, which may be electronic, electromagnetic, optical, infrared, or other signals capable of being received by communication interface(s). These signals may be provided to communication interface(s) via a communication path of a device, which may be implemented using, for example, wire or cable, fiber optics, a cellular link, a radio frequency (RF) link and/or other communications channels. Communication interface(s) may communicate using one or more communication protocols, such as Ethernet, Wi-Fi, near-field communication (NFC), Infrared Data Association (IrDA), Bluetooth, Bluetooth low energy (BLE), Zigbee, Long-Term Evolution (LTE), 5G New Radio (NR), vehicle-to-everything (V2X), a controller area network (CAN), or a local interconnect network (LIN), etc.

Accordingly, the operations of the method or algorithm described in connection with example embodiment(s) disclosed in the specification may be directly implemented with a hardware module, a software module, or a combination of the hardware module and the software module, which is executed by the processor 1100. The software module may reside on a storage medium (i.e., the memory 1300 and/or the storage 1600) such as RAM, a flash memory, ROM, an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

Although each component has been described above with a focus on a first side of the active rear diffuser 1, it may be clearly understood by one having ordinary skill in the art that some components may be respectively disposed on both sides in a longitudinal direction of the active rear diffuser 1. In addition, the operations of each component may be clearly recognized by one having ordinary skill in the art in light of the contents of the present specification.

According to some forms of the present disclosure, there is provided an active rear diffuser including: an actuator; a tilting mechanism configured to tilt the active rear diffuser by driving of the actuator; and a deployment mechanism configured to deploy the active rear diffuser through the driving of the actuator and by a completion of a tilting operation of the tilting mechanism.

According to some forms of the present disclosure, there is provided an active rear diffuser including: a fixing bracket; a cover configured to be tilted with respect to the fixing bracket; and a diffuser body configured to be deployed with respect to the cover, wherein the diffuser body is capable of being deployed after tilting of the cover is completed.

According to the present disclosure, the active rear diffuser and the vehicle including the active rear diffuser capable of increasing the aerodynamic force performance are provided.

According to the present disclosure, the active rear diffuser and the vehicle including the active rear diffuser capable of being tilted and extended by the single actuator are provided.

According to the present disclosure, the active rear diffuser and the vehicle including the active rear diffuser having the advantage in terms of packaging are provided.

According to the present disclosure, the active rear diffuser and the vehicle including the active rear diffuser capable of minimizing the failure caused by the complex driving component are provided.

According to the present disclosure, the active rear diffuser and the vehicle including the active rear diffuser capable of reducing the cost are provided.

The effects that can be obtained from the present disclosure are not limited to the above-mentioned effects, and other effects not mentioned herein will be clearly understood by one having ordinary skill in the art from the following description.

According to the present disclosure, by enabling tilting and deploying of the active rear diffuser with the single actuator, a simplified design is capable of being realized and the material cost is capable of being reduced.

Example embodiments of the present disclosure are described in detail above. However, the present disclosure is not limited to these example embodiments. It would be apparent to a person of ordinary skill in the art that various modifications to the present disclosure are possible within the scope of the technical idea of the present disclosure.

What is claimed is:

1. A diffuser of a vehicle, the diffuser comprising:
a diffuser body;
an actuator;
a tilting mechanism configured to tilt the diffuser body by driving the actuator; and
a deployment mechanism configured to deploy the diffuser body through the driving of the actuator and by a completion of a tilting operation of the tilting mechanism.

2. The diffuser of claim 1, further comprising:
a cover that is tiltable, the cover being configured to be tilted with respect to a fixing bracket by the tilting mechanism; and
a diffuser body configured to be deployed with respect to the cover by the deployment mechanism.

3. The diffuser of claim 2, wherein the tilting mechanism comprises a tilting gear coupled to the cover and being tiltable about a shaft, and a maximum tilting range of the tilting gear is limited by the fixing bracket.

4. The diffuser of claim 3, further comprising:
a carrier gear configured to selectively receive a driving force of the actuator through a main shaft connected to the actuator, the carrier gear being configured to be engaged with the tilting gear.

5. The diffuser of claim 4, wherein the deployment mechanism comprises:
a brake connected to the shaft and configured to hinder rotation of the shaft; and
a stopper body configured to lock the brake before tilting of the tilting gear.

6. The diffuser of claim 5, wherein the stopper body comprises:
a stopping surface configured to catch the brake; and
a passage disposed adjacent to the stopping surface, wherein the brake is movable along the passage based on a rotation of the brake.

7. The diffuser of claim 5, wherein the brake is configured to be unlocked from the stopper body based on the tilting of the tilting gear being limited by the fixing bracket.

8. The diffuser of claim 7, wherein the deployment mechanism comprises a ring gear configured to selectively receive the driving force of the actuator through the main shaft, and wherein the ring gear is further configured to rotate based on the brake being unlocked.

9. The diffuser of claim 8, further comprising:
a transmission gear configured to engage with the ring gear and to transmit a rotational force of the ring gear to the shaft.

10. The diffuser of claim 9, further comprising:
a threaded rod coupled to the shaft such that the brake is linearly moved by the rotation of the shaft.

11. The diffuser of claim 10, further comprising:
a link structure;
wherein the link structure connects the brake with the diffuser body.

12. The diffuser of claim 11, wherein the link structure comprises:
a connection link rotatably coupled to the brake; and
a main link coupled to the diffuser body to be movable in the diffuser body, the main link being coupled to the connection link such that the main link is rotatable with respect to the connection link.

13. The diffuser of claim 12, wherein the diffuser body comprises a track configured to guide movement of the main link.

14. The diffuser of claim 8, further comprising:
a sun gear mounted on the main shaft; and
a plurality of planet gears disposed around the sun gear and configured to engage with the sun gear,
wherein the ring gear is disposed radially outward of the plurality of planet gears such that the ring gear is engaged with the plurality of planet gears, and
wherein the carrier gear is mounted on the second shaft.

15. A diffuser of a vehicle, the diffuser comprising:
a bracket;
a cover configured to tilt with respect to the bracket; and
a diffuser body configured to be deployed with respect to the cover,
wherein the diffuser body is configured to be deployed after the cover is completely tilted.

16. The diffuser of claim 15, further comprising:
an actuator;
a tilting gear coupled to the cover and tiltable; and
a carrier gear engaged with the tilting gear and configured to receive a rotational force by a main shaft connected to the actuator.

17. The diffuser of claim 16, further comprising:
a shaft connected to the tilting gear; and
a brake connected to the shaft and configured to be locked or unlocked based on a rotation of the shaft by the tilting gear.

18. The diffuser of claim 17, wherein the tilting gear is configured such that the tilting gear is stopped by unlocking of the brake, and
wherein the diffuser further comprises:
a ring gear configured to rotate by receiving the rotational force from the main shaft based on the brake being unlocked; and
a transmission gear configured to engage with the ring gear and the shaft.

19. The diffuser of claim 18, further comprising:
a threaded rod connected to the shaft, wherein a thread is formed on an outer circumferential surface of the threaded rod,
wherein the brake is mounted on the threaded rod.

20. The diffuser of claim 19, further comprising:
a link structure configured to connect the brake and the diffuser body to each other.
